(19) United States
(12) Patent Application Publication
(10) Pub. No.: US 2026/0263302 A1
(43) Pub. Date: Sep. 10, 2026

(54) BED APPARATUS AND TRANSPORTATION DEVICE

(71) Applicant: PARAMOUNT BED CO., LTD., Tokyo (JP)

(72) Inventors: Ryuhei YOKOTA, Tokyo (JP); Yuki Nakamura, Tokyo (JP); Kentaro Kodaira, Tokyo (JP); Junji Mano, Tokyo (JP); Masaki Yamanoi, Tokyo (JP); Kentaro Hara, Tokyo (JP)

(73) Assignee: PARAMOUNT BED CO., LTD., Tokyo (JP)

(21) Appl. No.: 19/557,664

(22) Filed: Mar. 5, 2026

(30) Foreign Application Priority Data
Mar. 7, 2025 (JP) 2025-036528

(51) Int. Cl. A61G 7/08; G05D 1/228; G05D 107/60

(52) U.S. Cl. CPC A61G 7/08; G05D 1/228; A61G 2203/22; A61G 2203/32; G05D 2107/65

(57) ABSTRACT

A bed apparatus includes a wheel, a driving unit configured to transmit a driving force to the wheel, a control unit configured to control the driving unit, an operation device, a connection unit to which an operation device is connectable, and an acquisition unit configured to acquire a position at which the operation device is placed. The control unit is configured to determine a direction of moving the bed apparatus based on the position at which the operation device is placed and an operation signal from the operation device. The control unit is configured to control the driving unit.

### CROSS-REFERENCE TO RELATED APPLICATIONS

This application claims priority to Japan Patent Application No. 2025-036528 filed Mar. 7, 2025, which is incorporated by reference herein in its entirety.

### FIELD

The present disclosure relates to a bed apparatus and the like.

### BACKGROUND

For example, as described in JP2008-119452A, a bed transportation apparatus is disclosed, in which an electric transportation device for assisting transportation is provided for a transportation bed, a switch for actuation is provided for a grip for bed transportation, and the electric transportation device is driven only by gripping the grip by a transporter.

### BRIEF DESCRIPTION OF THE DRAWINGS

FIG. 1 is a view illustrating a schematic (entire) bed apparatus in a first embodiment.

FIG. 2 is a view illustrating the schematic bed apparatus in the first embodiment.

FIG. 3 is a view illustrating the state of a connection unit of the bed apparatus in the first embodiment.

FIG. 4 is an enlarged view illustrating the state of the connection unit of the bed apparatus in the first embodiment.

FIGS. 5A to 5C are views illustrating a schematic first operation device in the first embodiment.

FIG. 6 is a diagram illustrating a functional configuration in the first embodiment.

FIGS. 7A and 7B are a diagram and a table illustrating a software configuration in the first embodiment.

FIG. 8 is a chart illustrating the flow of processing in the first embodiment.

FIGS. 9A and 9B are views illustrating an operation example in the first embodiment.

FIG. 10 is a chart illustrating the flow of processing in a second embodiment.

FIGS. 11A to 11C are views illustrating an operation example in a third embodiment.

FIG. 12 is a view illustrating the state of a connection unit of a bed apparatus in a fourth embodiment.

FIG. 13 is a diagram illustrating a functional configuration in a fifth embodiment.

FIG. 14 is a view illustrating a schematic bed apparatus in a sixth embodiment.

### DETAILED DESCRIPTION

One or more embodiments are now described with reference to the drawings, wherein like reference numerals are used to refer to like elements throughout. In the following description, for purposes of explanation, numerous specific details are set forth in order to provide a thorough understanding of the various embodiments. It is evident, however, that the various embodiments can be practiced without these specific details (and without applying to any particular networked environment or standard) .

As used in this disclosure, in some embodiments, the terms "component, " "system" and the like are intended to refer to, or comprise, a computer-related entity or an entity related to an operational apparatus with one or more specific functionalities, wherein the entity can be either hardware, or a combination of hardware and software in execution.

One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software stored on a non- transitory electronic memory or firmware that confers at least in part the functionality of the electronic components. While various components have been illustrated as separate components, it will be appreciated that multiple components can be implemented as a single component, or a single component can be implemented as multiple components, without departing from example embodiments. Further, the various embodiments can be implemented as a method, apparatus or article of manufacture using standard programming and/or engineering techniques to produce software, firmware, hardware or any combination thereof to control a computer to implement the disclosed subject matter. The term "article of manufacture" as used herein is intended to encompass a computer-readable (or machine-readable) device or computer-readable (or machine-readable) storage/communications media having a computer program stored thereon. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words "example" and "exemplary" are used herein to mean serving as an instance or illustration. Any embodiment or design described herein as "example" or "exemplary" is not necessarily to be construed as preferred or advantageous over other embodiments or designs. Rather, use of the word example or exemplary is intended to present concepts in a concrete fashion. As used in this application, the term "or" is intended to mean an inclusive "or" rather than an exclusive "Or". That is, unless specified otherwise or clear from context, "X employs A or B" is intended to mean any of the natural inclusive permutations. That is, if X employs A; X employs B; or X employs both A and B, then "X employs A or B" is satisfied under any of the foregoing instances. In addition, the articles "a" and "an" as used in this application and the appended claims should generally be construed to mean "one or more" unless specified otherwise or clear from context to be directed to a singular form.

Embodiments described herein can be exploited in substantially any wireless communication technology, comprising, but not limited to, wireless fidelity (Wi-Fi), global system for mobile communications (GSM) , universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra mobile broadband (UMB), high speed packet access (HSPA), Z- Wave, Zigbee and other 802.XX wireless technologies and/or legacy telecommunication technologies.

In general, one aspect of the present application is a bed apparatus including a wheel, a driving unit configured to transmit a driving force to the wheel, a control unit configured to control the driving unit, a connection unit to which an operation device is connectable, and an acquisition unit configured to acquire a position at which the operation device is placed, the control unit being configured to determine a direction of moving the bed apparatus based on the position at which the operation device is placed and an operation signal from the operation device, the control unit being configured to control the driving unit.

Another aspect of the present application is a transportation device attachable to a bed apparatus including a wheel, a driving unit configured to transmit a driving force to the wheel, a control unit configured to control the driving unit, a connection unit to which an operation device is connectable, and an acquisition unit configured to acquire a position at which the operation device is placed, the control unit being configured to determine a direction of moving the bed apparatus based on the position at which the operation device is placed and an operation signal from the operation device, the control unit being configured to control the driving unit.

According to the present disclosure, the easily intuitively operable bed apparatus and the like can be provided.

There has been known a bed apparatus provided with an electric transportation device for assisting transportation and provided with a user interface for bed transportation in order to easily transport the bed apparatus.

Generally, the operation device for bed transportation is provided in one direction such as a foot side or a head side, and cannot be replaced. For this reason, there is a problem that when the direction of the bed apparatus cannot be changed in a narrow passage or a sickroom, the operation device cannot be replaced and usability is degraded.

In recent years, due to the necessity of the flexibility of a layout in which the bed apparatus is placed, there have been increasing demands for replacement of the operation device on the foot side or the head side as necessary, but these demands cannot be satisfied because the position is fixed.

In a case where the position of the operation device is merely changed, there is a new problem that a direction of operating the operation device and a direction of actually moving the bed apparatus do not match each other.

Hereinbelow, a bed system, a bed apparatus, a control device, and an operation device for solving the one or multiple problems above will be described.

### 1. FIRST EMBODIMENT

### 1.1 Overall Configuration

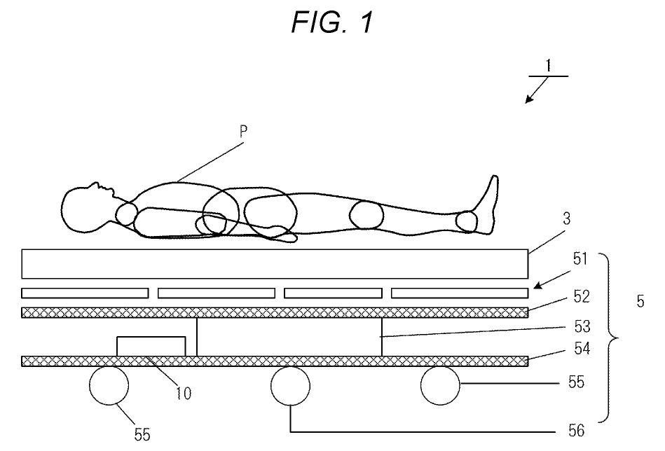

FIG. 1 is a view schematically illustrating a bed system 1 in this embodiment. As illustrated in FIG. 1, in the bed system 1, a mattress 3 is placed on a bed apparatus 5.

Note that the mattress 3 may be an urethane mattress or an air mattress. Alternatively, the mattress 3 may be a hybrid mattress obtained by combining urethane and air cells. Still alternatively, the mattress 3 may be an elastic body used for bedding such as a polyester fiber structure, gel, or a spring.

The bed system 1 is used by a user P. For example, when the user lies on the bed apparatus 5 (mattress 3), the left side in FIG. 1 is a head side and the right side in FIG. 1 is a foot side. In addition, assuming that the user P has a standard size, the back of the user P is located at the position of a back section, and the waist of the user is located at a curve section or a seat section.

Here, among those using the bed system, the user indicates a person actually using the bed apparatus 5, for example. For example, the user indicates a patient hospitalized in a hospital or a facility, a care recipient, or a person lying on the bed apparatus 5 (mattress 3) at home.

In this embodiment, a staff indicates a person supporting the user. For example, the staff includes a medical staff such as a doctor and a nurse in a hospital, a caring staff in a facility, a family member of the user at home, and the like.

In addition, in this embodiment, an operator indicates a person operating the bed system 1 (bed apparatus 5) . The operator is mainly the staff, but includes the user when the user operates the bed system (bed apparatus).

Further, the body posture of the user in this embodiment includes the position of the user and the posture of the user. The position of the user is his/her position (sleeping position) on the mattress 3. The posture of the user is the posture (sleeping posture) of the user at the time of sleeping on the mattress 3. The body posture may also include his/her posture at the time of not sleeping, such as an edge sitting position or a long sitting position.

### 1.2 Configuration of Bed Apparatus

The configuration of the bed apparatus 5 will be described with reference to the drawings.

### 1.2.1 Overview

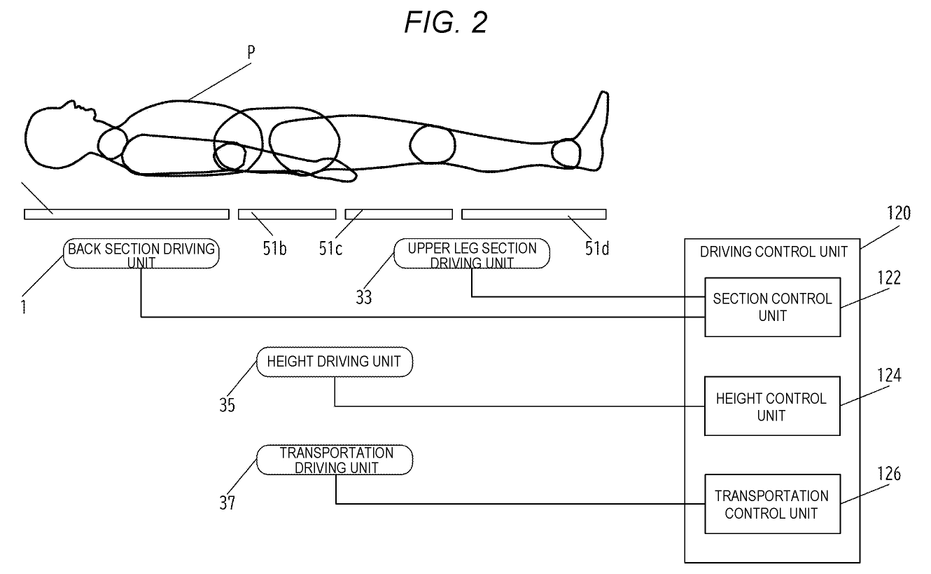

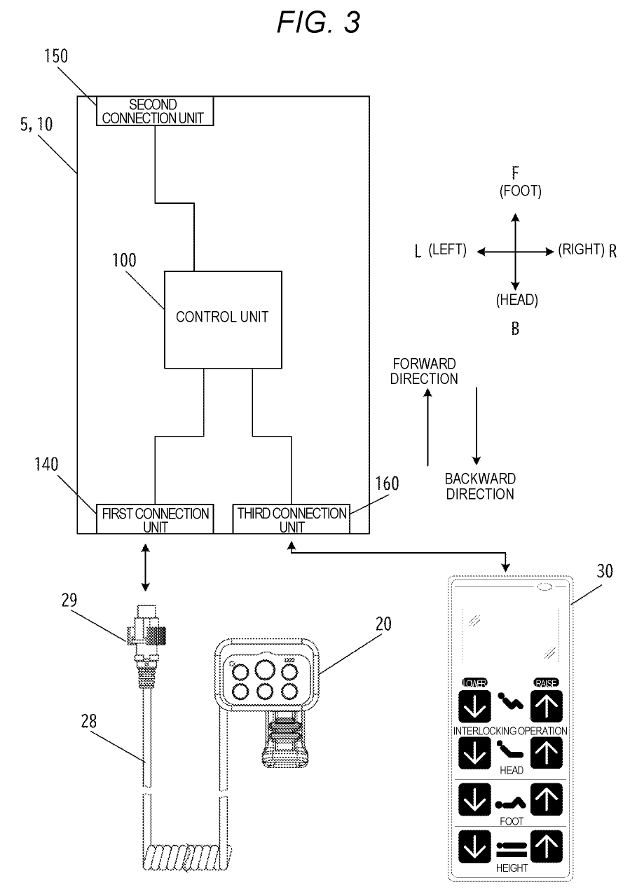

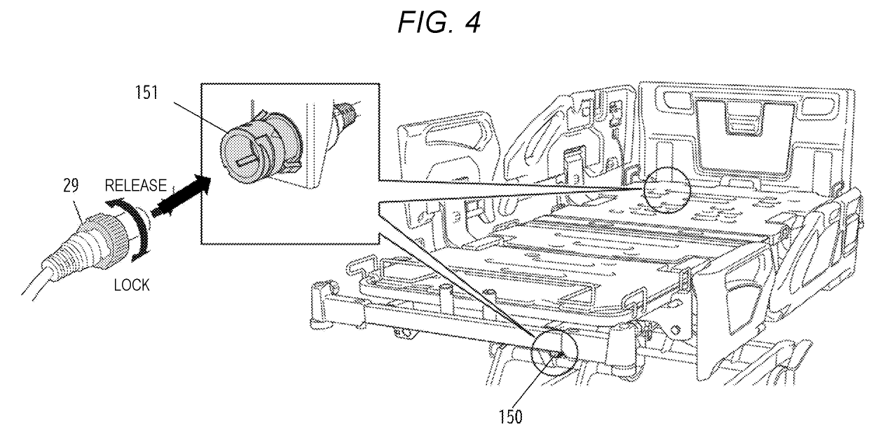

FIG. 2 is a view illustrating connection of driving units (drive device) of the bed apparatus 5. FIG. 3 is a view schematically illustrating connection of a control device 10 for controlling the bed apparatus 5 and the operation device for operating the bed apparatus 5. FIG. 4 is an enlarged view of a connection portion between a plug and a socket.

The bed apparatus 5 includes sections 51, an upper frame 52, and a lower frame 54 in the order from the top, and has a lifting mechanism 53 between the upper frame 52 and the lower frame 54. In addition, the lower frame 54 is provided with wheels 55. The wheels 55 are pivotally supported by the lower frame 54 so as to be turnable, and include two wheels provided below a first longitudinal end of the lower frame 54 and two wheels provided below a second longitudinal end of the lower frame 54, the two wheels at each longitudinal end are spaced apart from each other in the lateral direction of the bed apparatus 5, and the two wheels at the first longitudinal end are spaced from the two wheels at the second longitudinal end in the longitudinal direction. For example, the wheels 55 may include four wheels provided near four corners of the lower frame 54. The wheels 55 are used for moving the general bed apparatus 5 and may be provided by using any publicly known method.

The bed apparatus 5 is also provided with a wheel 56, other than the wheels 55, which is movable in all directions. The wheel 56 may include a pair of wheels provided to each of the right and left of the lower frame 54. The wheel 56 may include one or multiple wheels. The wheel 56 is preferably an all-direction wheel, for example, and is preferably a mecanum wheel capable of moving in all directions, for example. Alternatively, the wheel 56 may be an omni wheel.

The bed apparatus 5 is also provided with a transportation driving unit 37 for driving the wheel 56. The transportation driving unit 37 is a motor for transmitting a driving force to the wheel 56. The transportation driving unit 37 may be located at a different location from the wheel 56, or may be provided in the wheel 56 as an in-wheel motor.

Further, a rotational shaft of the motor is coupled to a rotational shaft of the wheel 56, and the rotational velocity of the rotational shaft of the motor is equal to the rotational velocity of the wheel 56. Here, the moving velocity of the bed apparatus 5 can be calculated by detecting the number of revolutions of the motor.

As illustrated in FIG. 2, the sections 51 include a back section 51a, a seat section 51b, an upper leg section 51c, and a lower leg section 51d in the order from the head side to the foot side at the time when the user P is in a lateral position on the bed apparatus 5 (mattress 3). Here, each section of the sections 51 is turnable by itself or in conjunction with the others. In addition, each of the sections 51 may be a piece of plate- shaped member or may be a bendable member formed in an accordion shape by multiple members.

For example, in a case where the seat section 51b is a curve section, the seat section can support the user by bending along with raising of the back section 51a. Alternatively, the seat section 51b may have a structure of extending or contracting while bending along with raising or lowering of the back section 51a.

Each of the sections is connected to a driving unit (drive device such as an actuator), for example. The sections 51 are turnable in response to operation of the driving unit. Note that the sections 51 do not necessarily have to be connected to the driving units on a one-to-one correspondence, and one driving unit can cause the multiple sections to operate by using a link mechanism, for example. In addition, the sections 51 operate in conjunction with each other by coupling adjacent sections.

Further, by turning each of the sections, the bed apparatus 5 implements operations such as a back raising operation, an upper-leg raising operation, and a lower-leg lowering operation. The bed apparatus 5 may implement the back raising operation and the upper-leg raising operation (foot lowering operation) in conjunction with each other.

The sections 51 are supported by the upper frame 52. The upper frame 52 may have any shape that supports the sections 51. In addition, the lower frame 54 may have any shape that supports the upper frame 52 supporting the sections 51.

The lifting mechanism 53 is for adjusting the height of the upper frame 52 and configured to adjust the height (floor height) of the bed apparatus 5. Here, the height of the bed apparatus 5 generally indicates a height (floor height) from a surface (ground surface) on which the bed apparatus is placed to the upper frame 52. Note that the height of the bed apparatus 5 may be a height from the ground surface to the sections 51.

The lifting mechanism 53 is implemented by the drive device (drive mechanism) such as a link mechanism or an actuator.

The driving units are described based on FIG. 2. A back section driving unit 31 can raise the back section 51a. For example, the back section driving unit 31 is an actuator, and connects the back section 51a to the tip of a rod of the actuator via the link mechanism.

An upper leg section driving unit 33 can raise the upper leg section 51c. For example, the upper leg section driving unit 33 is an actuator, and connects the upper leg section 51c to the tip of a rod of the actuator via the link mechanism.

In addition, each of the driving units is connected to a driving control unit 120. The driving control unit 120 functions as: a section control unit 122 that controls the back section driving unit 31 and the upper leg section driving unit 33; a height control unit 124 that controls a height driving unit 35; and a transportation control unit 126 that controls the transportation driving unit 37.

The section control unit 122 implements a back raising function and raises the back section 51a by controlling the back section driving unit 31.

The section control unit 122 implements an upper leg raising function and raises the upper leg section 51c by controlling the upper leg section driving unit 33. Note that by application of the driving force, the upper leg section 51c turns about the seat section 51b side of the upper leg section 51c as a fulcrum, so that the lower leg section 51d side of the upper leg section 51c is raised. At this time, the lower leg section 51d may turn in conjunction with the upper leg section 51c.

Meanwhile, the height control unit 124 implements a function of raising or lowering the bed apparatus 5 and can locate the upper frame 52 at a high or low position by controlling the height driving unit 35.

Note that in a case where the driving control unit 120 controls each of the driving units to perform a reverse operation to the above operation, the driving unit performs the reverse operation. That is, by inserting or retracting the rod of the actuator, the driving units can perform operations such as a back lowering operation, an upper leg lowering operation, and a floor height lowering operation on the bed apparatus 5.

By controlling the transportation driving unit 37, the transportation control unit 126 transmits, to the wheel 56, the driving force for moving the bed apparatus 5 and assisting movement of the bed apparatus 5. Here, the transportation control unit 126 can switch its mode between a first transportation mode and a second transportation mode.

Tn the first transportation mode, when operated by a first operation device 20, the transportation driving unit 37 generates the driving force in response to an operation signal and drives the wheel 56. Tn the second transportation mode, when no operation is made by the first operation device 20 and the staff is pushing the bed apparatus 5, the transportation driving unit generates the driving force for assisting the staff in pushing the bed apparatus 5 and drives the wheel 56.

Here, in the first transportation mode, the transportation driving unit 37 (motor) is actuated and generates the driving force so that the bed apparatus 5 can travel by itself. The driving force thus generated is transmitted to the wheel 56 and the wheel is rotated, so that the bed apparatus 5 moves. Meanwhile, in the second transportation mode, the transportation driving unit 37 is actuated and generates the driving force enough to assist the staff in pushing the bed apparatus 5.

For example, when initiating the movement of the bed apparatus 5, the operator find the bed apparatus 5 heavy and difficult to move. For this reason, the operator operates an operation button B20 (movement button B22) of the first operation device 20, so that the bed apparatus 5 travels by itself in a direction indicated by the operated movement button B22. Meanwhile, after the bed apparatus 5 starts moving, by pushing the bed apparatus 5 without operating the first operation device 20, the staff can cause the transportation driving unit to generate the driving force for assisting the staff according to the amount of pushing force the staff applied.

The driving force to be generated by the transportation driving unit 37 may be different between the first transportation mode and the second transportation mode, or may be different depending on the direction of movement. Thus, the moving velocity of the bed apparatus 5 is preferably within the following range, for example.

First transportation mode: forward movement 0.5 m/s to 0.7 m/s, backward movement 0.35 m/s to 0.55 m/s, lateral movement 0.1 m/s to 0.3 m/s

Second transportation mode: forward movement 0.9 m/s to 1.1 m/s, backward movement 0.9 m/s to 1.1 m/s, lateral movement 0.9 m/s to 1.1 m/s

The moving velocity is merely an example and may be able to be changed by the operator. In addition, the moving velocity of the bed apparatus 5 may be other than the above velocity.

In the first transportation mode, the staff can move the bed apparatus 5 in the direction indicated by the movement button B22 of the first operation device 20 by merely operating the movement button B22. Meanwhile, in the second transportation mode, while the staff is pushing the bed apparatus 5, the transportation driving unit 37 is actuated and the driving force thus generated is transmitted to the wheels 55 for the purpose of assisting the pushing force. This enables the staff to move the bed apparatus 5 with a light force by application of the driving force from the transportation driving unit 37 to his/her original force.

The transportation driving unit 37 may also have a brake function. For example, when a brake is ON, the transportation driving unit 37 may lock the wheels (or make the wheels hard to rotate by applying an excessive load on the wheels) to make the bed apparatus 5 immovable.

That is, the bed apparatus 5 of the present disclosure enables the staff to transport the bed apparatus 5 easily by switching the mode between the first transportation mode and the second transportation mode. Here, for the second transportation mode, techniques of providing an assist unit or the like for assisting transportation to the bed apparatus 5 can be used, such as JP2006-087598A (ELECTRIC CARRIER FOR BED, Filing Date: Sep. 22, 2004), JP2006-000328A (ELECTRIC CARRIER FOR BED AND DRIVING CONTROL METHOD THEREFOR, Filing Date: Jun. 16, 2004), and JP2004-194844A (ELECTRIC CARRIER IN BED AND DRIVING CONTROL METHOD THEREFOR, Filing Date: Dec. 17, 2002), and the contents of these applications may be incorporated by reference.

Note that the driving control unit 120 may have two configurations including a first driving control unit which includes the section control unit 122 and the height control unit 124 and a second driving control unit which includes the transportation control unit 126. In this case, the first operation device 20 to be described below can control the second driving control unit and a second operation device 30 to be described below can control the first driving control unit.

### 1.2.2 Operation Device

Next, the operation device will be described. In this embodiment, the first operation device 20 for operating movement of the bed apparatus 5 and the second operation device 30 for performing the operations of the bed apparatus 5 (such as a section operation and a height operation) can be connected to the control device 10 that controls the bed apparatus 5.

FIG. 3 is a view schematically illustrating connection between the control device 10, the first operation device 20, and the second operation device 30. Note that the control device 10 is provided for the bed apparatus 5 and FIG. 3 is a schematic plan view of the bed apparatus 5.

Here, directions in this embodiment will be described. In the case of FIG. 3 illustrating the bed apparatus 5 in plan view, the lower side is the head side of the user, and the upper side is the foot side of the user.

With reference to a case where the staff is on the head side, when the bed apparatus 5 is moved, the direction of movement from the head side to the foot side is a frontward direction (F). Also, when the bed apparatus 5 is moved, the direction of movement from the foot side to the head side is a rearward direction (B) . With reference to a case where the staff is on the head side, the direction of rightward movement in FIG. 3 is a rightward movement direction (R), and the direction of leftward movement in FIG. 3 is a leftward movement direction (L).

Here, the frontward, rearward, leftward, and rightward movement directions vary depending on the position of the staff, but are determined as absolute directions for the bed apparatus 5 (control device 10). A control unit 100 determines movement in the F direction as the frontward direction, movement in the B direction as the rearward direction, movement in the R direction as the rightward direction, and movement in the L direction as the leftward direction.

In this embodiment, a forward direction as the direction of movement of the bed apparatus 5 indicates a direction in which the bed apparatus 5 moves from the head side to the foot side of the bed apparatus 5. In addition, a backward direction as the direction of movement of the bed apparatus 5 indicates a direction in which the bed apparatus 5 moves from the foot side to the head side of the bed apparatus 5.

A first connection unit 140 and a second connection unit 150 can be connected to the first operation device 20. The first operation device 20 has a plug 29 as a connection terminal via a cable 28. The plug 29 is, for example, a male connector. For example, the plug 29 is connected to the first connection unit 140 or the second connection unit 150 as a mating socket, so that the operation signal can be transmitted to the control unit 100 of the control device 10. Note that the plug 29 of the first operation device 20 and the first connection unit 140 or the second connection unit 150 as the socket are mating connectors and may be referred to as a male connector and a female connector, for example. The plug 29 may be detachable from the first connection unit 140 or the second connection unit 150 as the socket.

Note that a portion to which the first operation device 20 can be connected includes two portions in this embodiment for the sake of convenience in description, but may include more than two portions. For example, the connection units to which the first operation device 20 can be connected may include four connection units provided to the left and right on the head side and the foot side, respectively. Alternatively, the connection units to which the first operation device 20 can be connected may be provided to the left and right of the bed apparatus 5 (this case will be described later in an embodiment).

FIG. 4 is a view schematically illustrating a state when the plug of the first operation device 20 is connected to the connection unit (socket). For example, the first connection unit 140 and the second connection unit 150 may have connection members respectively provided on the head side and foot side of the upper frame of the bed apparatus 5. For example, FIG. 4 is an enlarged view of a connection member 151 of the second connection unit 150.

By connecting the plug 29 to the connection member 151, the first operation device 20 is connected to the bed apparatus 5 (control device 10). Thereby, the operation signal from the first operation device 20 can be input to the control device 10.

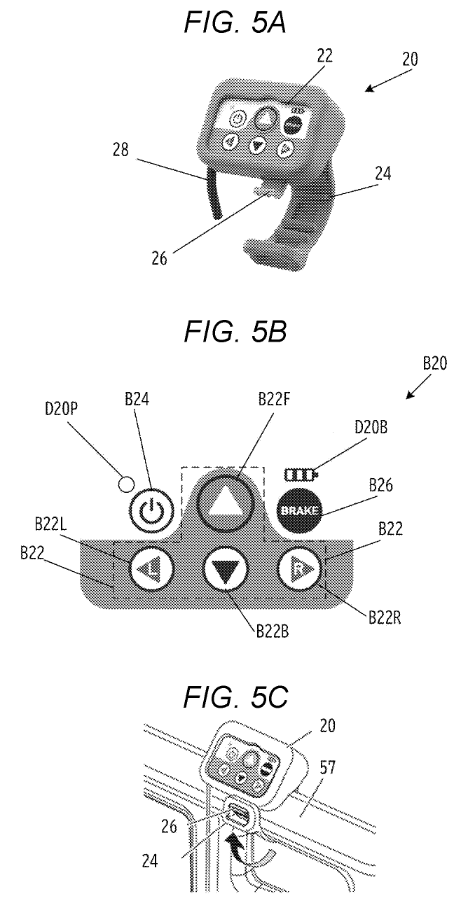

FIGS. 5A to 50 illustrate an example of the first operation device 20. As illustrated in FIG. 5A, the first operation device 20 includes an operation panel 22, a belt 24 as an attachment member, and a lock member 26. In addition, the first operation device 20 is connected to the control device 10 via the cable 28. The operation panel 22 has multiple operation buttons B20.

FIG. 5B is a view illustrating an example of the operation panel 22. For example, the operation panel 22 has the movement buttons B22 corresponding to four directions which correspond to the movement directions of the bed apparatus 5:

a frontward movement button B22F as a first operation button for movement in the frontward direction;

a rearward movement button B22B as a second operation button for movement in the rearward direction;

a rightward movement button B22R as a third operation button for movement in the rightward direction; and

a leftward movement button B22L as a fourth operation button for movement in the leftward direction.

Here, the above shows the four directions as an example of the movement buttons B22 corresponding to the movement directions, but the number of directions may be more than or less than the four directions. For example, the directions indicated by the movement buttons B22 may be two directions including the frontward and rearward directions (leftward and rightward directions) or may be eight directions including directions oblique to the upward, downward, leftward, and rightward directions.

The operation panel 22 may have an operation button other than the movement buttons B22 corresponding to the movement directions. For example, in FIG. 5B, the operation panel 22 may include the following buttons:

a power button B24 as a fifth operation button for power ON/OFF; and

a brake button B26 as a sixth operation button for causing the bed apparatus 5 not to move (putting a brake on the bed apparatus 5).

The operation panel 22 may have a notifier in addition to the operation buttons B20. For example, the notifier may be a sound output unit such as a buzzer and voice, or may be light, a display, and voice, or the like . For example, in FIG. 5B, the operation panel 22 includes the followings:

a power lamp D20P as a first notifier that notifies that the power is ON; and

a remaining amount lamp D20B as a second notifier that notifies the remaining amount of a battery of the first operation device 20.

Note that in this embodiment, the operation buttons B20 are hardware buttons in consideration of operator's operability (for allowing the operator to easily feel a sense of manipulating the buttons). However, the operation buttons B20 may be software buttons using a touch panel, for example.

FIG. 5C specifically illustrates an operation example of attaching the first operation device 20 to the bed apparatus 5. For example, a case of providing the first operation device to a frame 57 of a head board (foot board) provided on the head side (foot side) of the bed apparatus 5 will be described.

The first operation device 20 is placed on the frame 57. Then, the belt 24 is wound around the frame 57 to attach the first operation device 20 to the frame 57. Then, the belt 24 is fixed by the lock member 26.

Note that another method is conceivable as a method of fixing the first operation device 20 to the bed apparatus 5. For example, a dedicated attachment member may be provided on the foot board or the head board so that the first operation device 20 can be easily attached thereto and detached therefrom. Alternatively, for example, a magnet or the like may be provided on the first operation device 20 to fix the first operation device to the frame 57 using a magnetic force.

In addition, a third connection unit 160 can be connected to the second operation device 30. The second operation device 30 can perform an operation of controlling the back section driving unit 31, the upper leg section driving unit 33, and the height driving unit 35 of the bed apparatus 5.

Note that the second operation device 30 and the first operation device 20 may be integrated into one device. Alternatively, the first operation device 20 may be a touch panel or the like to function as the second operation device 30.

### 1.2.3 Functional Configuration

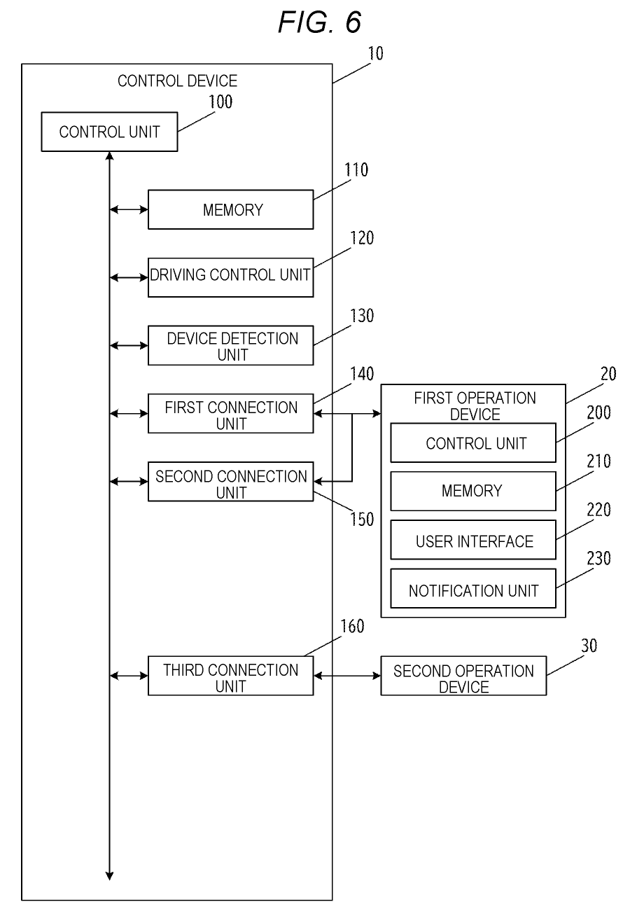

Subsequently, functional configurations of the control device 10 and the first operation device 20 will be described with reference to FIG. 6.

The control unit 100 is configured to control the entire control device 10. The control unit 100 implements various functions by reading and executing various programs stored in a memory 110 (such as a storage or a ROM). The control unit 100 may be implemented by one or multiple control devices/calculation devices (central processing unit (CPU), a system on a chip (SoC)). In addition, the control unit 100 may include one or multiple control circuits.

The memory 110 stores programs, data, and the like. For example, the memory 110 may be a storage, a ROM, a RAM, or the like. In addition, the memory 110 may have a configuration including a cache memory and the like included in other functional units (such as the control unit 100 and the driving control unit 120).

Here, the storage is a nonvolatile storage device that can store the programs and the data. For example, the storage may be a storage device such as a hard disk drive (HDD) or a solid state drive (SSD). Alternatively, the storage may be an externally connectable USB memory. Still alternatively, the storage may be, for example, a storage area on a cloud.

The ROM is a nonvolatile memory capable of keeping the programs and the data even when the power is turned off. The RAM is a main memory mainly used by the control unit 100 when executing the processing. The RAM is a rewritable memory that temporarily keeps the programs read from the storage and the ROM and the data including results at the time of execution of the processing.

As illustrated in FIG. 2, the driving control unit 120 is configured to control the drive device. For example, the driving control unit 120 controls the driving units such as the back section driving unit 31, the upper leg section driving unit 33, the height driving unit 35, and the transportation driving unit 37.

A device detection unit 130 functions as the acquisition unit and detects a position at which the first operation device 20 is placed. For example, the device detection unit 130 detects whether the first operation device 20 is placed on the head side or foot side of the bed apparatus 5. There are some methods of detecting the position at which the first operation device 20 is placed by the device detection unit 130, but such a position is detected by the following methods, for example.

(1) The position is detected by the connection unit to which the first operation device 20 is connected.

For example, it is assumed that the first connection unit 140 is on the head side of the bed apparatus 5 and the second connection unit 150 is on the foot side of the bed apparatus 5. In this case, for example, when the first operation device 20 is connected to the first connection unit 140, the device detection unit 130 detects that the first operation device 20 is placed on the head side. When the first operation device 20 is connected to the second connection unit 150, the device detection unit 130 detects that the first operation device 20 is placed on the foot side.

(2) Position detector is used.

For example, the bed apparatus 5 is provided with the position detector. Specifically, tags (RFID tag or NFC tag) storing identification information are placed on the head side and foot side of the bed apparatus 5, and the first operation device 20 acquires the identification information. By receiving the identification information by the first operation device 20, the device detection unit 130 detects the position at which the first operation device 20 is placed. As the position detector other than the tag, for example, the position may be detected by magnetism, or may be detected based on the shape of a member on which the first operation device is placed.

It may be configured such that the first operation device 20 can be operated by the position detector only when receiving the information from the tags. In this case, the first operation device 20 is required to be operated in a state of being kept attached to the bed apparatus 5, and the operator cannot operate the first operation device 20 in a state of the first operation device being separated from the bed apparatus 5 (for example, the first operation device being held with a hand).

Alternatively, near field communicator may be used as the position detector, and the position may be detected when the first operation device 20 is located nearby. For example, in a case where the first operation device 20 is unwired or an application is installed in a smartphone to implement the first operation device 20, the first operation device 20 can be operated from a distant location. Thus, using a tag of Bluetooth Class 3 or NFC as the near field communicator, it may be configured such that the first operation device 20 cannot be operated when the position cannot be detected because the identification information cannot be acquired.

(3) The position is selected by the operator.

For example, the operator may input the position from the first operation device 20 or the second operation device 30. For example, by setting using a switch indicating a position or the operation buttons B20 to the first operation device 20, the position of the first operation device 20 may be input. The device detection unit 130 detects the position of the first operation device 20 according to the input position.

The first connection unit 140 and the second connection unit 150 are connection units to which the first operation device 20 can be connected. Meanwhile, -the third connection unit 160 is a connection unit to which the second operation device 30 can be connected. These connection units may have any form of connection by which these operation devices can be connected, as illustrated in FIG. 3. For example, the connection units are sockets, ports, receptacles, and the like capable of transmitting and receiving electric signals, and are also connectors (female connectors) . The first connection unit 140 and the second connection unit 150 may use existing techniques such as a universal serial bus (USB) and RS-232C. Note that in FIG. 6, the number of connection units to which the first operation device 20 can be connected is two, but may be three or more.

Note that the first operation device 20 may include a control unit 200, a memory 210, a user interface 220, and a notification unit 230. The control unit 200 and the memory 210 have the same configurations as those of the control unit 100 and the memory 110.

The user interface 220 is a unit that accepts an operation from the operator, and includes the operation buttons B20 described in FIGS. 5A to 5C, for example.

The notification unit 230 is a unit that notifies the operator and the like of various states, and is implemented by light (such as an LED lamp), sound (such as a buzzer or voice), vibration, and the like, for example.

Note that the first operation device 20 may be provided with a display instead of the notification unit 230. Alternatively, in the first operation device 20, the user interface 220 and the notification unit 230 may be integrally formed by using a touch panel as the display.

### 1.2.4 Software Configuration

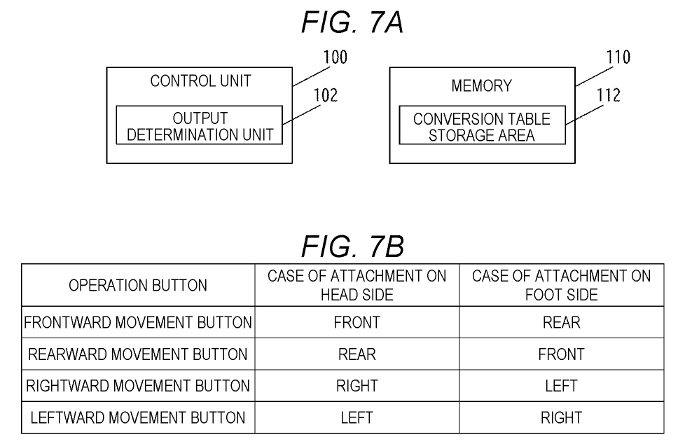

A software configuration will be described with reference to FIGS. 7A and 7B.

The control unit 100 functions as an output determination unit 102 by reading a program stored in the memory 110 and executing the program.

The output determination unit 102 determines motor output included in a control signal output to the motor of the transportation driving unit 37. The output determination unit 102 determines the motor output as the driving force according to the first transportation mode and the second transportation mode.

In the first transportation mode, the output determination unit 102 determines the motor output previously determined according to the operation buttons B20. Note that in the first transportation mode, the staff may be able to change output such as "weak", "medium", and "strong".

Meanwhile, in the second transportation mode, the output determination unit 102 may adjust the motor output such that (transportation force) = (human operation force) + (motor output determined according to input).

Then, the control unit 100 generates the control signal based on a motor output value determined by the output determination unit 102 and a movement direction determined based on the input from the operation buttons B20 and the attachment position of the first operation device 20.

As illustrated in FIG. 7A, a conversion table storage area 112 for storing a conversion table is allocated in the memory 110.

As illustrated in FIG. 7B, the conversion table stores the movement button B22 of the operation buttons B20 and the direction in which the bed apparatus 5 is moved by the movement button B22. For example, when the first operation device 20 is attached on the head side, the bed apparatus 5 moves in the direction corresponding to the movement button B22. For example, when the frontward movement button B22F is selected by the operator, if the first operation device 20 is placed on the head side of the bed apparatus 5, the movement direction is the "frontward" direction. That is, the bed apparatus 5 moves in the forward direction (direction from the head side to the foot side of the user).

Here, the button may be selected by pressing down the button in a case where the button is a physical switch (hardware button). Alternatively, the button may be selected by a touch operation or the like in a case where the button is a capacitive switch or a software key displayed on a touch panel. Still alternatively, in a case where a voice operation can be performed, the button may be operated by the voice operation. That is, each button may be selected by any method by the operator or the like.

When the first operation device 20 is attached on the foot side, the bed apparatus 5 moves in a reverse direction to the direction corresponding to the movement button B22. For example, when the frontward movement button B22F is selected by the operator, if the first operation device 20 is placed on the foot side of the bed apparatus 5, the movement direction is the "rearward" direction. That is, the bed apparatus 5 moves in the backward direction (direction from the foot side to the head side of the user).

In this manner, the conversion table stores the same direction (forward direction as a first direction) as that corresponding to the movement button B22 when the first operation device 20 is attached on the head side. On the other hand, the conversion table stores the reverse direction (backward direction as a second direction) to that corresponding to the movement button B22 when the first operation device 20 is attached on the foot side. In addition, the conversion table also stores the opposite directions in the left-right direction when the first operation device is attached on the head side and the foot side.

### 1.3 Flow of Processing

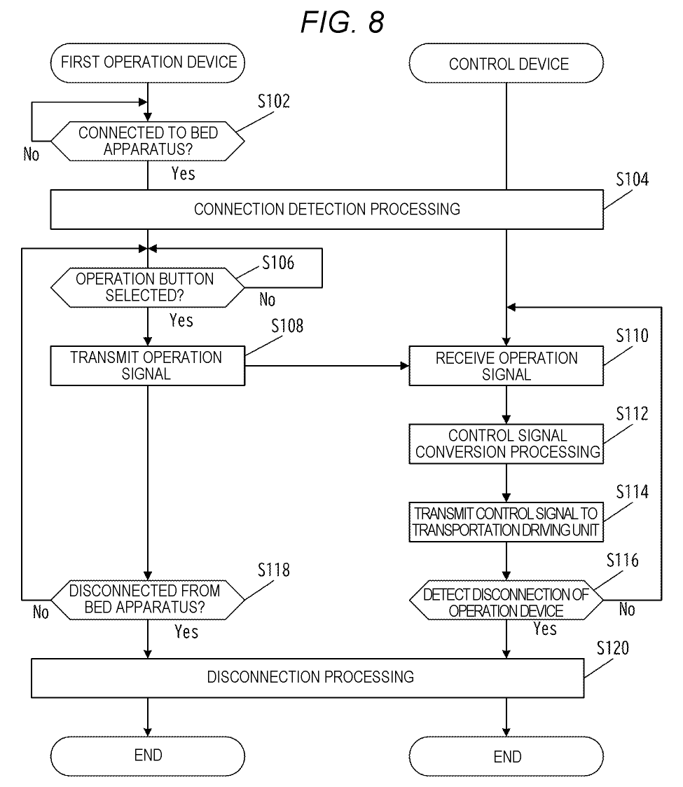

Subsequently, the flow of processing will be described with reference to FIG. 8. Note that FIG. 8 is applicable to a general operation device, but in this embodiment, the first operation device 20 will be described as an example.

First, when the first operation device 20 is connected to the bed apparatus 5 (S102; Yes), the control device 10 and the first operation device 20 execute connection detection processing of detecting connection of the first operation device 20 (S104).

The connection detection processing can detect that the first operation device 20 is connected to the control device 10 and detect the position (terminal to which the the first operation device 20 is connected, location where the first operation device 20 is placed) at which the first operation device 20 is connected. In addition, the connection detection processing may also acquire the state (such as the remaining amount of the battery) of the first operation device 20, for example.

The connection detection processing may detect that the control device 10 and the first operation device 20 are physically connected to each other, or may detect the first operation device 20 by receiving a connection signal from the first operation device 20, for example. By accurately executing the connection detection processing, the first operation device 20 and the control device 10 are brought into a communicable state.

Subsequently, when the operation button B20 is selected in the first operation device 20 (S106; Yes), the control unit 200 transmits the operation signal to the control device 10 (S108). When the control device 10 receives the operation signal (5110), the control unit 100 executes control signal conversion processing (S112). By executing the control signal conversion processing, the control unit 100 converts the operation signal corresponding to the operation button B20 selected in the first operation device 20 into the control signal.

For example, when the frontward movement button B22F is selected as the operation button B20, the control unit 100 receives an operation signal for frontward movement in 5110. Then, the control unit 100 converts the operation signal for frontward movement into the control signal according to the position at which the first operation device 20 is placed. In addition, the control signal may include the output value for the transportation driving unit 37, which is determined by the output determination unit 102. That is, by rotating the motor (such as the motor coupled to the wheel 56) according to the output value, the driving force is applied to the wheel 56.

Referring to FIG. 7B, in a case where the first operation device 20 is attached on the head side, when the frontward movement button B22F is selected, the control unit 100 converts the operation signal into a "fron^{t}ward" control signal as the control signal. In a case where the first operation device 20 is attached on the foot side, when the frontward movement button B22F is selected, the control unit 100 converts the operation signal into a "rearward" control signal as the control signal. In this manner, the control unit 100 converts the operation signal into the control signal based on the position at which the first operation device 20 is attached and the operation signal. That is, the control unit 100 applies the driving force by the transportation driving unit 37 to the wheel 56. The control unit 100 determines a direction of applying the driving force to the wheel 56.

The control unit 100 transmits the control signal to the transportation driving unit 37 (3114). That is, by transmitting the control signal from the driving control unit 120 to the transportation driving unit 37, the motor is operated to rotate the wheels 56 to assist transportation of the bed apparatus 5.

Then, until the first operation device 20 is disconnected from the bed apparatus 5, the first operation device 20 repeats the processing of S106 and S108 (S118; No). Similarly, until the first operation device 20 is disconnected, the control device 10 transmits the control signal according to the operation signal (S116; No).

Here, when the first operation device 20 is disconnected from the bed apparatus 5 (3118; Yes, 3116; Yes), the bed system 1 executes processing of disconnecting the first operation device 20 (S120). Thereby, the control device 10 can stop reception of the operation signal from the first operation device 20.

### 1.4 Operation Example

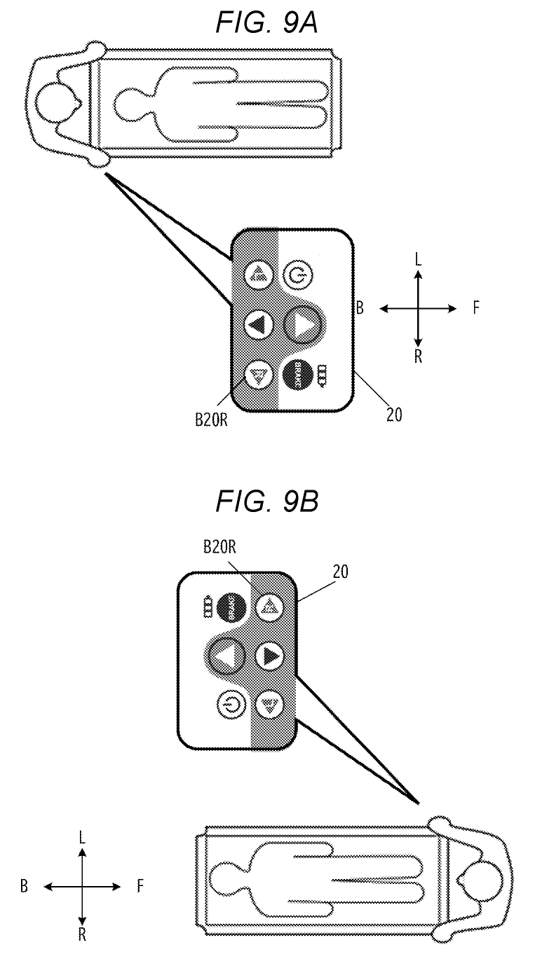

FIGS. 9A and 9B are views illustrating an operation example in this embodiment. FIG. 9A is a view illustrates an operation example of attaching the first operation device 20 on the head side. For example, when the operator selects the rightward movement button B22R at this time, the bed apparatus 5 moves in the rightward direction as viewed from the operator. That is, the bed apparatus 5 moves in the R direction.

FIG. 9B is a view illustrates an operation example of attaching the first operation device 20 on the foot side. For example, when the operator selects the rightward movement button B22R at this time, the bed apparatus 5 moves in the rightward direction as viewed from the operator. However, at this time, the bed apparatus 5 moves in the L direction.

In this manner, according to this embodiment, the bed apparatus 5 is switched between movement in the forward direction and movement in the backward direction according to an operator's operation on the operation button B20 (movement button B22) based on the attachment position of the first operation device 20. In addition, from the point of view of the operator, the operator can constantly feel as if the bed apparatus 5 moves in the same direction as that indicated by the operation button B20 (movement button B22) provided on the operation panel.

That is, in this embodiment, a direction from the position at which the first operation device 20 is placed to the position on the opposite side thereof is a direction in which the bed apparatus 5 moves forward as viewed from the operator. Thus, since the first operation device 20 is placed on the head side in FIG. 9A, when the operator operates the first operation device 20 to move the bed apparatus 5 in the frontward direction, the bed apparatus 5 moves in the direction from the head side on which the first operation device 20 is placed to the opposite foot side. In addition, since the first operation device 20 is placed on the foot side in FIG. 9B, when the operator operates the first operation device 20 to move the bed apparatus 5 in the frontward direction, the bed apparatus 5 moves in the direction from the foot side on which the first operation device 20 is placed to the opposite head side.

In this embodiment, the driving force may be determined according to the movement direction. For example, the control unit 100 may control the transportation driving unit 37 such that different driving forces are generated in the frontward direction, the rearward direction, the rightward direction, and the leftward direction. Alternatively, the control unit 100 may control the transportation driving unit 37 such that the same driving force is generated between the rightward direction and the leftward direction.

### 2. Second Embodiment

Subsequently, a second embodiment will be described. In the first embodiment, the control device 10 converts the operation signal into the control signal, but in the second embodiment, the first operation device 20 performs such conversion. Note that the second embodiment is substantially the same as the first embodiment in configurations and the like, and therefore, in the following description, contents common to those of the first embodiment will be omitted and characteristic contents in this embodiment will be mainly described.

In the second embodiment, the conversion table storage area 112 illustrated in FIG. 7A may be allocated in the memory 210 of the first operation device 20, and may store the conversion table.

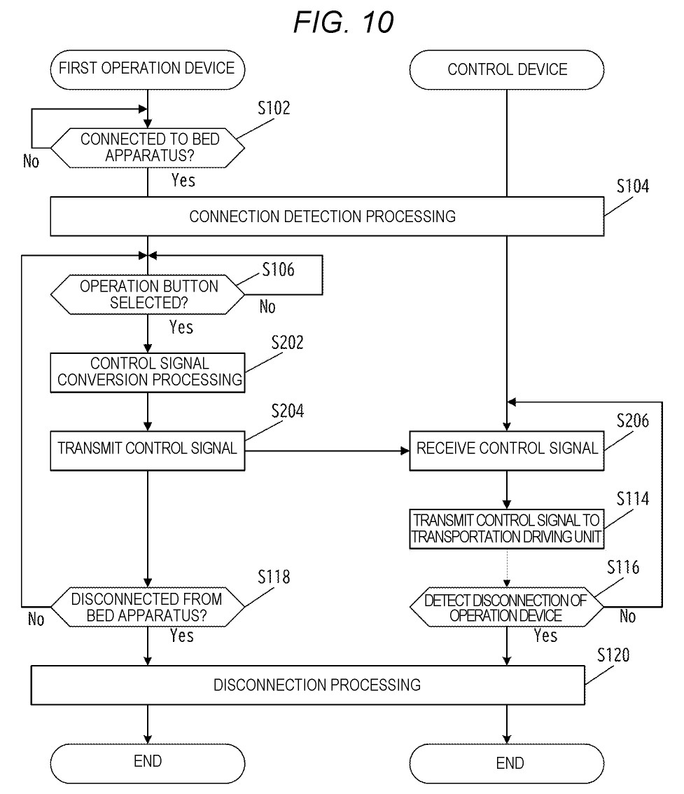

FIG. 10 is a chart illustrating a processing example where the first operation device 20 converts the operation signal generated by pressing of the operation button B20 into the control signal. Note that the processing of FIG. 10 is obtained by replacing a part of the processing illustrated in FIG. 8 with different processing, and identical processing steps are denoted by identical reference numerals and description thereof will be omitted.

In FIG. 10, in the connection detection processing (S104), the connection position of the first operation device 20 may be acquired. For example, the control unit 200 may acquire information on the connected connection unit from the bed apparatus 5. Alternatively, for example, a tag or a two-dimensional code indicating the connection position may be attached as position information to the bed apparatus 5, and by reading the position information, the control unit 200 may acquire the position at which the first operation device 20 is placed on the bed apparatus 5.

When the operation button B20 is selected in 3106, the control unit 200 of the first operation device 20 converts the operation signal into the control signal (3202). That is, the first operation device 20 converts the operation signal into the control signal with reference to the conversion table according to the position at which the first operation device 20 is attached on the bed apparatus 5. Then, the control unit 200 transmits the converted control signal to the control device 10 (S204).

The control unit 100 of the control device 10 may receive the control signal (S206), and may transmit the control signal to the drive device (S114).

### 3. Third Embodiment

Subsequently, a third embodiment will be described. The third embodiment is an embodiment in which the operation button B20 of the first operation device 20 is implemented by a software key using a touch panel. Note that the third embodiment is substantially the same as the first embodiment in configurations and the like, and therefore, in the following description, contents common to those of the first embodiment will be omitted and characteristic contents in this embodiment will be mainly described.

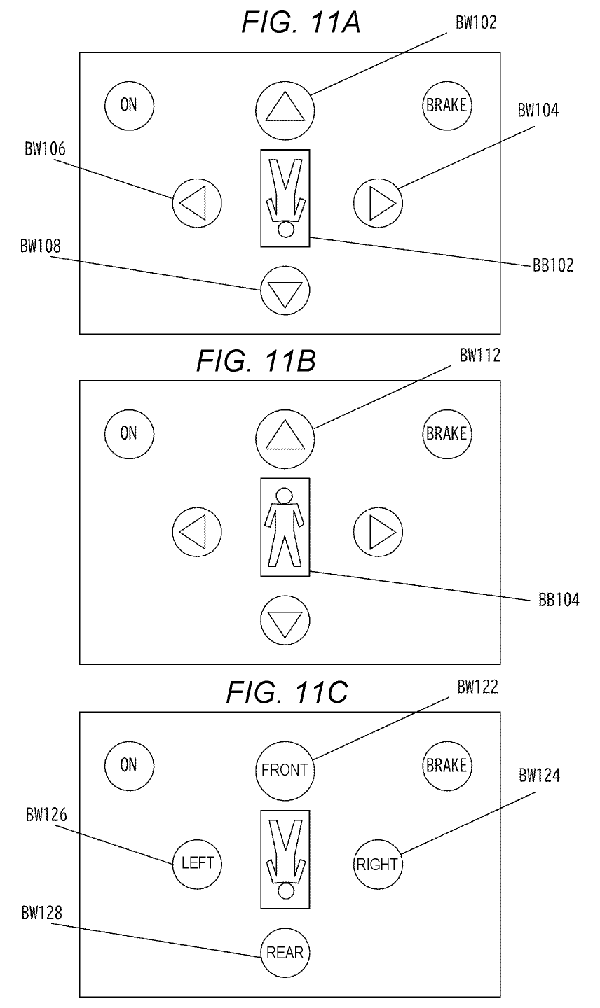

In the above embodiment, the operation button B20 of the first operation device 20 can be implemented in a flexible display form by using, for example, a touch panel integrated with the display device. For example, as illustrated in FIG. 11A, the first operation device 20 may display software keys BW102, BW104, BW106, BW108. In addition, a display screen of the first operation device 20 may display the state (orientation) of the bed apparatus 5 as BB102.

In this manner, for example, when the direction of control on the bed apparatus 5 changes due to a change in the position at which the first operation device 20 is connected/placed as illustrated in FIG. 11B, the indication of BB104 indicating the state of the bed apparatus 5 changes. This enables the staff to easily recognize that for example, when the staff selects BW102 in FIG. 11A, the bed apparatus 5 moves from the head side to the foot side, but when the staff selects BW112 indicating the same direction in FIG. 11B, the bed apparatus 5 moves from the foot side to the head side.

The display form of the button may be changed. For example, as illustrated in FIG. 11C, the display forms of the button BW122, the button BW124, the button BW126, and the button BW128 can be changed to "FRONT", "RIGHT", "LEFT", and "REAR". In this manner, the first operation device 20 can be provided, which enables the staff to easily intuitively recognize the position.

### 4. Fourth Embodiment

Subsequently, a fourth embodiment will be described. The fourth embodiment is an embodiment in which multiple connection units to which the first operation device 20 can be connected are provided, and for example, an embodiment in a case where the first operation device 20 is placed at a position other than the head side and foot side of the bed apparatus 5. Note that the fourth embodiment is substantially the same as the first embodiment in configurations and the like, and therefore, in the following description, contents common to those of the first embodiment will be omitted and characteristic contents in this embodiment will be mainly described.

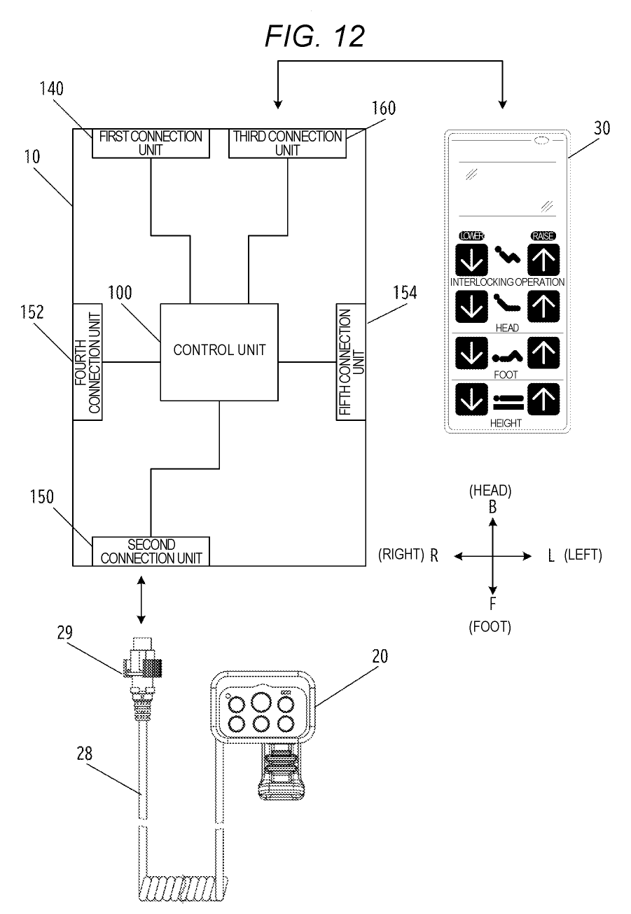

In the above embodiment, the case where the first operation device 20 is attached on the head side or the foot side has been described. However, the first operation device 20 may be placed at the side of the bed apparatus 5. For example, in FIG. 12, a fourth connection unit 152 is provided on the right side of the bed apparatus, and a fifth connection unit 154 is provided on the left side of the bed apparatus. For example, in a case where the first operation device 20 is connected to the fifth connection unit 154, when the frontward movement button B22F is pressed, the control signal is output to move the bed apparatus in the R direction. That is, the control signal is assigned to the movement button B22 such that the bed apparatus moves by 90 degrees.

In this manner, in the above embodiment, according to the attachment position of the first operation device 20, the operation signal and the control signal are changed to the forward direction and the backward direction (opposite directions by 180 degrees), but may be changed to directions rotated rightward and leftward by 90 degrees.

That is, similarly to the above embodiment, in this embodiment, a direction from one end side on which the first operation device 20 is placed to the opposite other end side is determined as a direction of moving the bed apparatus 5 forward. When the operation button B20 (movement button B22) of the first operation device 20 is operated, even in a case where the first operation device 20 is placed at any position, the bed apparatus 5 moves in the direction matching the direction of the operation button B20 (movement button B22) as viewed from the operator.

The connection units to which the first operation device 20 can be connected in this embodiment may include multiple connection units on each side (front, rear, left, and right). That is, the connection units to which the first operation device 20 can be connected may include two or more connection units, and according to the position at which the first operation device 20 is connected, the movement button B22 and the movement direction correspond to each other.

### 5. Fifth Embodiment

Subsequently, a fifth embodiment will be described. The fifth embodiment is an embodiment in which when the first operation device 20 is connected to the bed apparatus 5, the first operation device is connected via another device. Note that the fifth embodiment is substantially the same as the first embodiment in configurations and the like, and therefore, in the following description, contents common to those of the first embodiment will be omitted and characteristic contents in this embodiment will be mainly described.

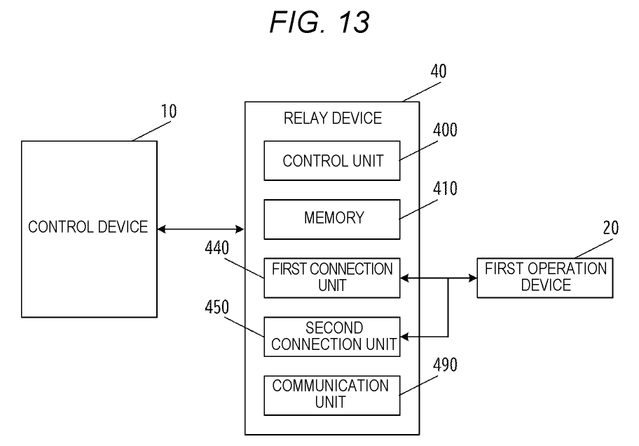

FIG. 13 is a diagram illustrating a functional configuration in this embodiment. This embodiment is an embodiment in which a relay device 40 is provided between the control device 10 and the first operation device 20.

The relay device 40 includes a control unit 400, a memory 410, a first connection unit 440, a second connection unit 450, and a communication unit 490. The control unit 400 and the memory 410 are units for operating the relay device 40, and for example, have similar functions to those of the control unit 100 and the memory 110 of the control device 10 and the control unit 200 and the memory 210 of the first operation device 20.

The first connection unit 440 and the second connection unit 450 have similar functions to those of the first connection unit 140 and the second connection unit 150 of the control device 10. Note that when the relay device 40 is used, the bed apparatus 5 does not necessarily have the first connection unit 140 and the second connection unit 150. Note that the number of connection units to which the first operation device 20 can be connected is not limited to two and may be more than two.

For example, the relay device 40 may be able to be separated from the first connection unit 440 and the second connection unit 450 in a wired or wireless manner. In this manner, for example, the first connection unit 440 can be placed on the head side of the bed apparatus 5, and the second connection unit 450 can be placed on the foot side of the bed apparatus 5. In addition, the control unit 400 may set the position at which the first connection unit 440 or the second connection unit 450 is placed.

The relay device 40 can communicate with the control device 10 via the communication unit 490. The communication unit 490 performs communication in a wired or wireless manner. For example, communication can be made by connecting the communication unit 490 of the relay device 40 and a communication unit (not illustrated) of the control device 10 in a wired manner. A method of performing communication by the communication unit 490 may be not only a dedicated line but also communication according to a standard such as a universal serial bus (USB). Alternatively, the communication unit 490 may use a communication method such as a wireless LAN. Still alternatively, the communication unit 490 may communicate with the control device 10 by using any publicly known method.

The relay device 40 may execute, for example, part of the processing illustrated in FIG. 8. For example, the control unit 400 of the relay device 40 may execute S104, 5110, S112, S114, and the like of FIG. 8. That is, the relay device 40 receives the operation signal from the first operation device 20. Then, the relay device 40 may convert the operation signal into the control signal, and may transmit the control signal to the bed apparatus 5.

### 6. Sixth Embodiment

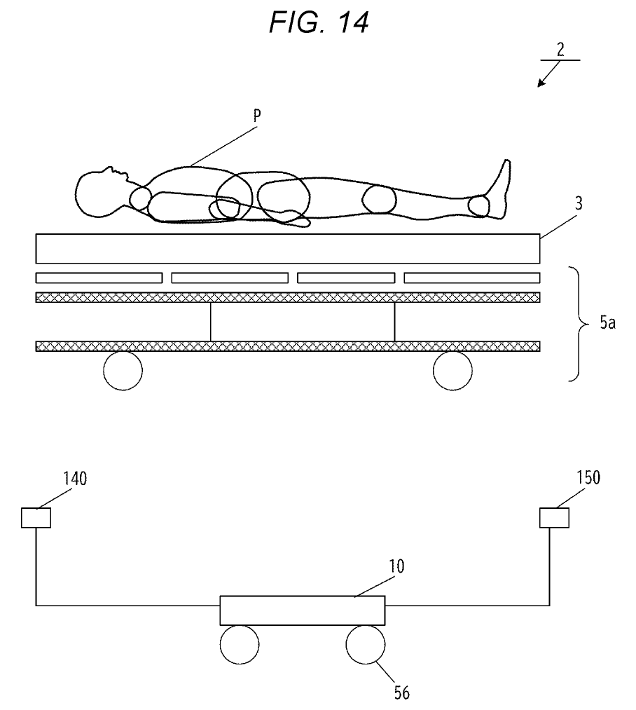

Subsequently, a sixth embodiment will be described. The sixth embodiment is an embodiment in which the transportation device is refitted to an existing bed apparatus afterwards. FIG. 14 is a view illustrating an example of a system 2 in this embodiment. A bed apparatus 5a of the system 2 is an existing bed apparatus and is not provided with the control device 10 having the transportation function of the present disclosure.

The control device 10 is attached afterwards to the bed apparatus 5a not having the control device 10. For example, the control device 10 is attached to the lower frame, for example. Here, the control device 10 is attached to a position at which the wheel 56 connected to the control device 10 is in contact with the ground. In addition, the control device 10 is provided, in a wired or wireless manner, with the first connection unit 140 and the second connection unit 150 to which the first operation device 20 is connected. The first connection unit 140 is provided on the head-side lower frame or upper frame of the bed apparatus Sa, for example, whereas the second connection unit 150 is provided on the foot-side lower frame or upper frame of the bed apparatus 5a, for example. Note that the number of connection units to which the first operation device 20 can be connected is not limited to two and may be more than two.

The functions having been described in the above embodiments can be thereby implemented in the existing bed apparatus easily.

### 7. Modification Examples

The present disclosure is not limited to each of the above-described embodiments, and various modifications can be made thereto. That is, embodiments that can be implemented by combining technical means appropriately modified within the scope that does not depart from the gist of the present disclosure are also included in the technical scope.

In the above-described embodiments, the description has been given of the case where the transportation device is mainly applied to the bed apparatus, but apparatuses to which the transportation device is applied are not limited to the bed apparatus. For example, the bed apparatus also includes a home use bed and a stretcher, in addition to a hospital bed (a bed in a sickroom, an ICU bed, an operating table, or a treatment table) and a care bed. In addition, in terms of an apparatus that can travel by itself, the transportation apparatus is also applicable to apparatuses such as a cart and a wheelchair.

The above-described embodiments are divided for convenience of the description. However, the embodiments can be combined and implemented within the realm of possibility. It is also intended to acquire the rights to any of the techniques disclosed in the present specification in the forms of an amendment, a divisional application, and the like.

Moreover, the program that operates in each device in the respective embodiments is a program that controls a CPU or the like (a program that causes a computer to function) so as to implement the functions in the abovementioned embodiments. Further, the information that is handled by these devices is temporarily stored in a temporary storage (for example, RAM) at the time of processing, and thereafter stored in various ROM and HDD storage devices, and is read and corrected/written by the CPU as necessary.

Herein, as a recording medium that stores the program, any of a semiconductor medium (for example, a ROM and a nonvolatile memory card), an optical recording medium, a magneto-optical recording medium (for example, a digital versatile disc (DVD), a compact disc (CD), and a Blu-ray (registered trademark) disc (BD)), a magnetic recording medium (for example, a magnetic tape and a flexible disc), and the like may be used.

Further, in a case of distribution to the market, the program can be stored and distributed in a portable recording medium, or transferred to a server computer connected via a network such as the Internet. In this case, a storage device of the server device, of course, falls within the present disclosure.

The above-described data is not stored in the device, but may be stored in an external device, and called, as appropriate. For example, data may be stored in a network attached storage (NAS), or stored on a cloud.

The respective functional blocks or various features of the devices used in the above-described embodiments can be implemented or executed by an electric circuit, for example, an integrated circuit or multiple integrated circuits. Electric circuits designed to execute the functions described in the present specification may include general purpose processors, digital signal processors (DSPs), application specific integrated circuits (ASICs), field programmable gate arrays (FPGAs), or other programmable logic devices, discrete gate or transistor logic, discrete hardware components, or combinations thereof. The general purpose processor may be a microprocessor or a processor, a controller, a microcontroller, or a state machine of the related art. The above-described electric circuit may be implemented by a digital circuit or may be implemented by an analog circuit. In a case where a technology of integrating circuits that replaces the current integrated circuit appears due to the progress of the semiconductor technology, one or more aspects in the present disclosure can also use a new integrated circuit based on the technology.

The scope of the present disclosure is not limited to the configurations that are explicitly described in the present specification, and includes combinations of the techniques disclosed in the present specification. In the present disclosure, the configurations, for which the applicant attempts to acquire a patent, are described in the claims. However, it is not intended that the configuration not described in the claims is excluded from the technical scope.

In the above-described specification, each of the expressions such as "in the case where ..." and "when ..." only represents one example, and thus the present disclosure is not limited to the contents described above. Configurations not described with these expressions are also disclosed within the scope that is apparent for those skilled in the art, and it is intended to acquire the rights to such configurations.

Orders of the processing and the data flow described in the present specification are not limited to the described orders. For example, the configuration in which the processing is partially omitted and the configuration in which the order of the processing is changed are also disclosed, and it is intended to acquire the right therefor.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A bed apparatus comprising:
a wheel;
a driving unit configured to transmit a driving force to the wheel;
a control unit configured to control the driving unit;
a connection unit to which an operation device is connectable; and
an acquisition unit configured to acquire a position at which the operation device is placed,
the control unit being configured to determine a direction of moving the bed apparatus based on the position at which the operation device is placed and an operation signal from the operation device, the control unit being configured to control the driving unit.

2. The bed apparatus according to claim 1, wherein the control unit determines the direction of moving the bed apparatus such that a direction from the position at which the operation device is placed to a position on an opposite side is a direction of moving the bed apparatus forward.

3. The bed apparatus according to claim 2, wherein the control unit further determines the driving force according to the movement direction.

4. The bed apparatus according to claim 1, wherein
the operation device is provided on one end side or the opposite other end side of the bed apparatus,
when a first button is selected,
in a case where the operation device is provided on the one end side, the direction of moving the bed apparatus is determined as a direction of moving the bed apparatus from the one end side to the other end side, and
in a case where the operation device is provided on the other end side, the direction of moving the bed apparatus is determined as a direction of moving the bed apparatus from the other end side to the one end side.

5. The bed apparatus according to claim 1, wherein
the control unit detects the position at which the operation device is placed based on a position of a connection unit to which the operation device is connected.

6. The bed apparatus according to claim 1, further comprising the operation device.

7. A transportation device attachable to a bed apparatus comprising:
a wheel;
a driving unit configured to transmit a driving force to the wheel;
a control unit configured to control the driving unit;
a connection unit to which an operation device is connectable; and
an acquisition unit configured to acquire a position at which the operation device is placed,
the control unit being configured to determine a direction of moving the bed apparatus based on the position at which the operation device is placed and an operation signal from the operation device, the control unit being configured to control the driving unit.

8. The transportation device according to claim 7, further comprising the operation device.
